(19) United States
(12) Patent Application Publication
(10) Pub. No.: US 2008/0313607 A1
(43) Pub. Date: Dec. 18, 2008

(54) UNIFIED INPUT STACK

(75) Inventors: Nakajima Yutaka, Redmond, WA (US); Suzue Yutaka, Issaquah, WA (US); Ryan A. Haveson, Monroe, WA (US); David R. Blythe, Kirkland, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/763,543

(22) Filed: Jun. 15, 2007

(51) Int. Cl. G06F 9/44

(52) U.S. Cl. 717/108

(57) ABSTRACT

A unified input stack is disclosed herein. The unified input stack defines a standard mechanism for input data promotion, centralizing the mechanism so that consumers of input data can retrieve the data from a known location in an ideal form. The unified input stack receives input data from an input device and stores the input data in a data object corresponding to the input data. Promoted data corresponding to the input data may then be received. The promoted data may include additional information abstracted from the input data. The promoted data may then be stored in the data object together with the input data. The data object may then be provided to one or more consumers.

### BACKGROUND

Input stacks in operating systems have many different forms of input promotion mechanisms, most of which are essentially taking a raw form of input data at various levels and “promoting” the input data with some abstraction and information added. As an illustrative example, when a physical key is depressed in an input device such as a keyboard, the keyboard generates a scan code as raw data. This scan code goes to the computer system's provided lookup table (i.e., keyboard layouts) and generates a next form of data that is a virtual key code in most cases. What occurred in the above example is that the raw data was promoted to the next level of information that could be used without device specific knowledge. Semantic information was added to the device specific data (i.e., the scan codes), and the semantic information could be used without the device specific knowledge (i.e., the virtual keys). This type of input data promotion occurs at various places in operating systems such as when input data generated by a touch panel is promoted to coordinate information, or when voice input data is promoted to a text string, etc.

Current operating systems support several independent mechanisms for a software application to use input data streams, including the ones with operating system supported event synchronization, promotion and routing services and the ones without integrated operating system support for these functions. As an example, a speech recognition service may employ its own framework to route input events to a software application, forcing the application to handle synchronization on its own. Additionally, it is likely that device specific input handlers for each type of input (e.g., speech, pen, touch panel, etc.) may also be required. Some of these problems may be partially mitigated by Text Services Framework (TSF), which helps synchronize text input providers to the operating system standard input stack. However, TSF is not entirely unified with the traditional input stack and therefore it does not provide the comprehensive support that is provided to keyboards and mice for non standard input streams. In view of the foregoing deficiencies in existing systems, there is a need for a new apparatus, system and method for providing input data to a software application.

### SUMMARY

A unified input stack is disclosed herein. The unified input stack defines a standard mechanism for input data promotion, centralizing the mechanism so that consumers of input data can retrieve the data from a known location in an ideal form. The unified input stack receives input data from an input device and stores the input data in a data object corresponding to the input data. Promoted data corresponding to the input data may then be received. The promoted data may include additional information abstracted from the input data. The promoted data may then be stored in the data object together with the input data. The data object may then be provided to one or more consumers.

The unified input stack may operate in combination with a number of input promoters. Input promoters are components with specific knowledge with regard to an input device, a form of input data, or a consumer of the input data. The input promoters generate promoted input data by adding additional information abstracted from the input data. Each input promoter may represent a particular promotion level with the lowest level input promoter providing promoted data to the next highest level input promoter and repeating this process until each promotion level has promoted the input data.

A lowest level input promoter may be referred to as a first level or “device” level input promoter, and it may provide physical data by taking device dependent raw input data and possibly performing normalization of the raw data or another transformation on the raw data to make it consumable for a next level of input promoters. A second level or “data” level input promoter may provide logical data using domain knowledge of a form of the data. A third level or “semantic” level input promoter may provide semantic data by taking highly processed data and performing some type of recognition on the data.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter. Rather, this summary is intended to serve as an introduction to the detailed description and figures that follow. Other features and advantages of the invention may become apparent from the following detailed description of the invention and accompanying drawings.

### BRIEF DESCRIPTION OF THE DRAWINGS

The illustrative embodiments will be better understood after reading the following detailed description with reference to the appended drawings, in which:

FIG. 1 is a block diagram representing an exemplary computing device.

FIG. 2 is a simplified block diagram representing an exemplary unified input stack.

FIG. 3 is a flow diagram highlighting an exemplary method for providing data from an input device to a software application.

### DETAILED DESCRIPTION

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies.

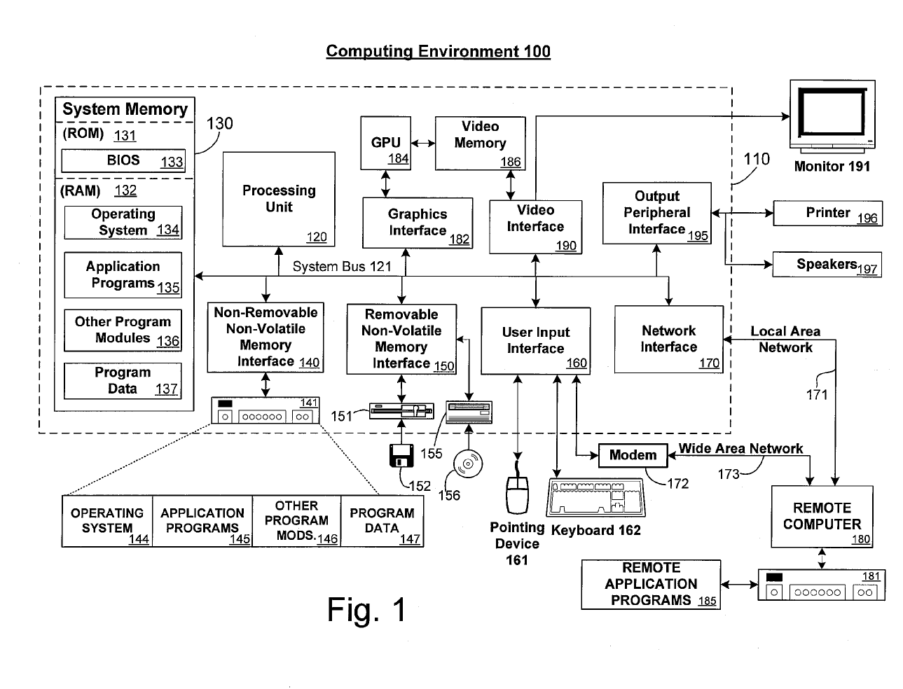

FIG. 1 illustrates an example of a suitable computing system environment 100 in which the subject matter described above may be implemented. The computing system environment 100 is only one example of a suitable computing environment and is not intended to suggest any limitation as to the scope of use or functionality of the subject matter described above. Neither should the computing environment 100 be interpreted as having any dependency or requirement relating to any one or combination of components illustrated in the exemplary operating environment 100.

With reference to FIG. 1, computing system environment 100 includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

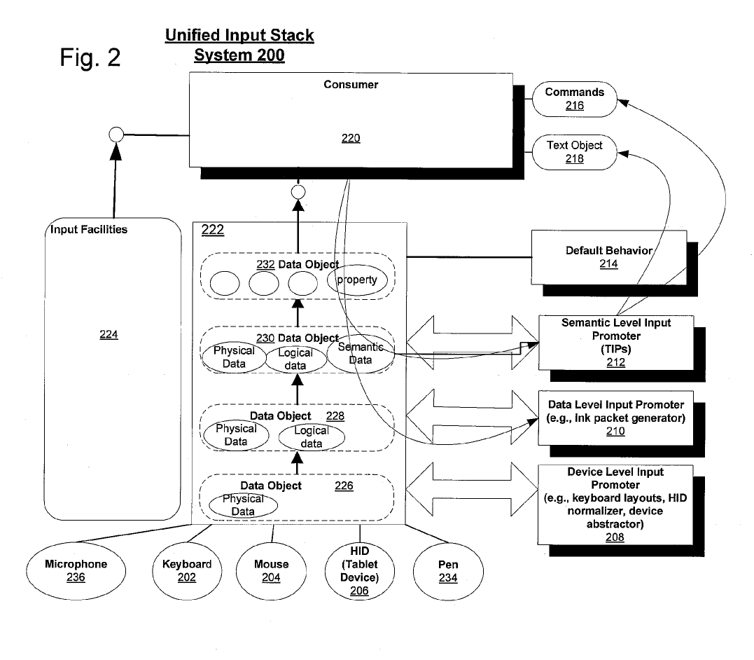

Referring now to FIG. 2 there is shown a block diagram of an exemplary unified input stack system 200. Input devices such as a keyboard 202, a mouse 204, tablet device 206, an input pen 234, and a microphone 236 are coupled to the unified input stack 222 which is preferably stored within computer 110 and acts upon input data received from one or more of the input devices. As should be appreciated, the input devices may be either internal or external to computer 110. The unified input stack defines a standard mechanism for input data promotion centralizing the mechanism so that a consumer 220 (e.g., any application/component/system within computer 110) of the input data can retrieve the data in an ideal form, either with or without promotion as may be required.

The unified input stack system 200 defines a component referred to as an “input promoter”. Input promoters are components with specific knowledge with regard to an input device, a form of input data, and/or a typical consumer of a form of input data. A device driver can present itself as an input promoter and an application can also perform input promotion. Additionally, input promotion can be provided by various support components provided by an operating system or by third party components. Some input promoters may be device class promoters which may be employed for various types of devices (e.g., pens, microphones, keyboards, etc.) made by different manufacturers. The exemplary input stack system 200 includes three levels of input promoters, but it should be appreciated that the present invention is not limited to three input promoters. An input stack in accordance with the present invention may include any number of input promoters.

The first level of input promoters in exemplary input stack system 200 is the device level input promoter 208, which takes device dependent input data and possibly performs normalization of the raw data or another transformation on the raw data to make it consumable for a next level of input promoters. For example, for keyboard 202 the device level input promoter 208 may be a keyboard layout. The device level input promoter 208 may convert a scan code from a keyboard 202 to a virtual key code. The unified input stack 222 which may, for example, be executing in computing device 110, takes the input data from the input device and the promoted data from the device level input promoter 208 and stores them in a data object 226 corresponding to the input data.

In the illustrative embodiment of FIG. 2, a second level input promoter or data level input promoter 210 is provided. The data level input promoter 210 has domain knowledge of a form of the data. For example, a sequence of coordinate data from a pen pad or a touch panel can be packaged by a data level input promoter into a form of ink, as in “Ink data”. The data level input promoter 210 provides promoted data that is logical data. Multiple data level input promoters can be selected amongst depending on, for example, what input device or application is being used. The logical data and the physical data are stored as a data object 228.

A third level input promoter or semantic level input promoter 212 is also included in the input stack system 200. The semantic level promoter 212 may take highly processed data, such as ink data or a packaged audio stream or a sequence of keystrokes and perform some type of recognition on the data. In particular, a sequence of keystrokes can be processed by the semantic level promoter 210 to generate a command or a text string in a particular language. For example, concurrent strokes of the Ctrl key and the C key can be converted into a “Copy” command. The semantic level promoter 212 provides semantic data corresponding to the input data. An illustrative example of a semantic level input promoter is a input method editor (IME), which is a program that allows computer users to enter complex characters and symbols, such as Japanese characters, using a standard keyboard. An IME may convert a series of keystrokes on a traditional English keyboard into a Japanese character. A data object 230 includes physical data, logical data and semantic data corresponding to the input data.

A default behavior handler 214 provides default properties to data object 232. The default properties may be those set by an operating system, such as when an inappropriate key is depressed on keyboard 202 when no application is currently running. Any input that can not be captured by a software application goes to the default behavior handler. For example, when the Windows key and the “M” key are depressed simultaneously, the default would be to minimize all windows. The default behavior handler provides promoted data to data object 232 in the form of properties that correspond to default behavior. The data objects, 226, 228, 230 and/or 232 are made available to a software application 220. As should be appreciated, although not shown in FIG. 2, each of the data objects 226, 228, 230 and/or 232 may also include the raw data received from the input devices.

In an illustrative example on how the device level promoter 208, data level input promoter 210 and the semantic level input promoter 212 operate on input data from an input device will now be briefly discussed in order to better understand the operation of the unified input stack system 200. In a first example, for input data originating from keyboard 202, the device level input promoter 210 takes the raw keyboard data and coverts it into individual key data (e.g., Ctrl key, X Key, etc.). The data level input promoter 210 recognizes a group of keystrokes (e.g., Ctrl X), while the semantic level input promoter 212 converts a group of keystrokes into a command, for example, it converts Ctrl X into a cut command. In a second example, for input pen 234, the device level promoter takes the raw pen data and converts it to device independent data. The data level input promoter coverts a series of pen coordinates into a line, curve, etc. While the semantic level input promoter recognizes that one or more lines or curves represent some sort of symbol, like for example a specific letter or shape.

Input facilities 224 may include facilities for additional inputs directed to consumer 220. Input facilities 224 may include, for example, focus tracking facilities, system event facilities, command target facilities, and command handler registering facilities. In particular, focus tracking facilities may keep track of which application among several concurrently running applications should be receiving and reacting to input from input devices. For example, an application which is currently in the foreground of a computer display is typically “in focus,” and, therefore, is tied to inputs from input devices. The unified input stack system may provide a set of standard facilities for input promoters to perform processing of input data received from an input device in a unified environment which can be shared by multiple applications. For example, to help perform command generation, the unified input stack may provide an API to retrieve an appropriate command target, depending on context.

In addition to providing semantic data to the unified input stack, the semantic level promoter 212 may provide commands 216 directly to the consumer 220 such as, for example, a cut command when a user has pressed the Ctrl X keys on keyboard 202. Text objects 218 may also be provided if required by an application such as, for example, when keystrokes are converted to a Chinese text object. Another example is when a word is written in the tablet device 206, the text object 218 may be a word or phrase text object.

Data objects 226, 228, 230 and/or 232 need not necessarily be separate data objects. Rather they may simply represent the same data object at various stages with various different contents. Data objects 226, 228, 230 and/or 232 provide a standard interface to handle raw and abstracted input data. The data objects 226, 228, 230 and/or 232 also provide simple application programming interfaces (APIs) to help control input data promotion. The data objects 226, 228, 230 and/or 232 provide a location to store input data in both a raw form and a processed form so if a software application needs to perform some operation on the raw data after obtaining highly processed data, it can do so with a single entry point. An application may not receive the input data object unless the application informs the systems to route it to the software application. An illustrative example would be as follows:

```
Interface IInputObject: IDataObject
{
  enum InputKind inputkind;
  BOOL IsRecognized( );
  BOOL GetRawData(void*pRaw);
  BOOL GetEvent(ILogicalEvent*pLogEvent);
  Void RocognizeInput(DWORD level, IRecognizedInput*pPE);
}
```

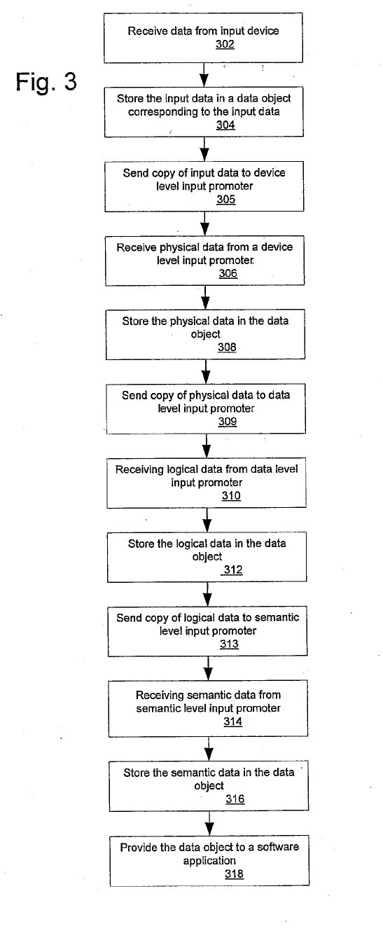

In FIG. 3 there is shown a flowchart highlighting an exemplary method for providing data from an input device to a software application. At act 302 input data is received from an input device such as keyboard 202, mouse 204, tablet device 206, pen 234, microphone 236 or any other appropriate input device. At act 304, the input data is stored in a data object corresponding to the input data. At act 305, a copy of all or a portion of the input data and possibly any other relevant data is sent to a device level input promoter, which generates physical data in accordance with the input data. At act 306, the physical data is received from the device level input promoter. At act 308, the physical data is stored along with the input data in the data object corresponding to the input data. At act 309, a copy of all or a portion of the physical data and possibly any other relevant data is sent to a data level input promoter, which logical physical data in accordance with the physical data. At act 310, the logical data is received from the data level input promoter. At act 312, the logical data is stored along with the input data and the physical data in the data object corresponding to the input data. At act 313, a copy of all or a portion of the logical data and possibly any other relevant data is sent to a semantic level input promoter, which generates semantic data in accordance with the physical data. At act 314, the semantic data is received from the semantic level input promoter At act 316, the physical data is stored along with the input data, the physical data, and the logical data in the data object corresponding to the input data. At act 318, all or any portion of the data object is provided to the software application.

The method depicted in FIG. 3 is merely one exemplary method for providing data from an input device to a software application. As should be appreciated, any number of zero or more input promoters in any appropriate order may be used in connection with the unified input stack to provide input data to an application. Additionally, it should be recognized that it is not always necessary for the unified input stack to actively send or provide data to the input promoters or the consumers (as depicted in acts 305, 309 and 313). Rather, data from the unified stack may be accessed by the input promoters and by consumers without requiring any action by the unified input stack. Additionally, in some scenarios, multiple input promoters may be employed at each level. For example, two or more semantic level input promoters may be used.

The particular input promoters that are used may be stored in a configuration or other type of file accessible to the unified input stack or may be provided on-the-fly by a consumer, an operating system, or by any other local or remote component, module or device. Additionally, the consumer itself may specify which input promoters are to be used. The consumer may also specify various types of promotion that are to be employed such as, for example, converting text to different languages, converting pen input to drawings, and the like. Furthermore, the consumer can provide context to the promoter to assist in the promotion process. For example, the consumer can provide a relevant text stream to assist in grammar and spell checking promotion. The consumer can also register for various levels of data. For example, a consumer can request semantic and logical data but not physical data, in which case the physical data may not be persisted.

Although the subject matter has been described in language specific to the structural features and/or methodological acts, it is to be understood that the subject matter defined in the appended claims is not necessarily limited to the specific features or acts described above. Rather, the specific features or acts described above are disclosed as example forms of implementing the claims.

What is claimed:

1. A computer readable medium for providing data from an input device to a software application, the computer readable medium having stored thereon computer executable instructions for performing steps comprising:
receiving input data from the input device;
storing the input data in a data object corresponding to the input data;
receiving promoted data corresponding to the input data, the promoted data comprising additional information abstracted from the input data;
storing the promoted data in the data object together with the input data; and
providing at least a portion of data in the data object to the software application.

2. The computer readable medium of claim 1, wherein the application selects the input promoter, a particular level of input promoter, or particular processes to be performed by the input promoter.

3. The computer readable medium of claim 1, wherein the application provides context information to the input promoter to assist in promoting the input data.

4. The computer readable medium of claim 1, wherein receiving promoted data comprises receiving device independent data from a device level input promoter.

5. The computer readable medium of claim 1, wherein receiving promoted data comprises receiving logical data from a data level input promoter.

6. The computer readable medium of claim 1, wherein receiving promoted data comprises receiving semantic data from a semantic level input promoter.

7. A system for providing data from an input device to an application, the system comprising:
a computing device;
a software application executing on the computing device;
an input promoter executing on the computing device, the input promoter receiving input data from an input device, the input promoter generating promoted data in accordance with the input data, the promoted data comprising additional information abstracted from the input data;
a unified input stack executing on the computing device, the unified input stack receiving the input data and the promoted data, storing the input data and the promoted data in a data object corresponding to the input data, and providing at least a portion of data in the data object to the software application.

8. The system of claim 7, wherein the input promoter is a device level input promoter and the promoted data is physical data.

9. The system of claim 7, wherein the input promoter is a data level input promoter and the promoted data is logical data.

10. The system of claim 7, wherein the input promoter is a semantic level input promoter and the promoted semantic is logical data.

11. The system of claim 7, wherein the input promoter is a support component provided by an operating system.

12. The system of claim 7, wherein the input promoter is the software application.

13. The system of claim 7, wherein the input promoter is a driver corresponding to the input device.

14. The system of claim 7, wherein the input promoter is a device class input promoter that promotes data from devices with similar functionality made by different manufacturers.

15. The system of claim 7, wherein the input promoter is selected by the software application.

16. A method for providing data from an input device to a software application, the method comprising:
receiving input data from the input device;
storing the input data in a data object corresponding to the input data;
receiving promoted data corresponding to the input data, the promoted data comprising additional information abstracted from the input data;
storing the promoted data in the data object together with the input data; and
providing at least a portion of data in the data object to the software application.

17. A method as defined in claim 16, wherein receiving promoted data comprises receiving physical data from a device level input promoter.

18. A method as defined in claim 16, wherein receiving promoted data comprises receiving logical data from a data level input promoter.

19. A method as defined in claim 16, wherein receiving promoted data comprises receiving semantic data from a semantic level input promoter.

20. A method as defined in claim 16, wherein the input promoter is selected by the application.
